(19) United States
(12) Patent Application Publication
(10) Pub. No.: US 2002/0004461 A1
(43) Pub. Date: Jan. 10, 2002

(54) High temperature superconductor

(75) Inventors: Wolfgang Neuberger, Labuan (MY); Andrei A. Donchak, Moscow (RU); Victor B. Kalinin, Moscow (RU)

Correspondence Address: BOLESH J. SKUTNIK PhD, JD, 515 Shaker Road, East Longmeadow, MA, 01028, US

(73) Assignee: CeramOptec Industries, Inc.

(21) Appl. No.: 09/900,676

(22) Filed: Jul. 6, 2001

Related U.S. Application Data
(60) Provisional application No. 60/216,608, filed on Jul. 7, 2000.

(51) Int. Cl. H01B 1/00

(52) U.S. Cl. 505/110; 505/482

(57) ABSTRACT

A new type of high temperature superconductor is described which is based on cubic phase Li₃P formed at high pressures. A method for creating Li₃P in a cubic phase either by itself or with up to 10% of Li₃N by molecular proportions is also presented. The synthesis of these superconductive compounds is described. Generally, a mixture of low pressure synthesized Li₃N and Li₃P is subjected to a combination of high pressure and high heat for a certain duration. The phases are monitored during synthesis with x-ray diffraction and mass-spectrometry. The resultant materials display superconducting transitions, T_{S}, above 225 K and approaching room temperature.

### BACKGROUND OF THE INVENTION

1. Domestic Priority Under 35 USC 119(e)

This application claims the benefit of U.S. Provisional Application No. 60/216,608, filed Jul. 7, 2000.

2. Field of the Invention

This invention relates to a new type of high temperature superconductor (HTSC) and a method of preparing these high temperature superconductors.

3. Invention Disclosure Statement

In 1910 Kammerlingh-Onnes opened up the superconductivity phenomenon with metallic mercury at 4.1 K. During the next 70 years, many metals and transitional metal compounds were carefully examined and by 1975 the best result was obtained at 23.3 K for Nb₃Ge. This result was not surpassed by anyone for many years. Investigators began researching the complex oxides and new superconductor like YBa₂Cu₃O₇ with a Tₛ of 90 K were discovered. Many scientists hunted for better Ts-values using more complicated compounds; however, the success at obtaining compounds has been mixed. Thus far, the highest Superconduction was obtained at 162 K for TlCa₄Ba₃Cu₆O₇, but the commercial usefulness of the compound was limited. Continued investigation for new compounds useful as superconductors revealed superconductive properties in Al—Si glasses. It was established that T s-value for Al—Si glasses is higher then the value for crystal samples. This discovery suggests the importance of crystalline structures in the search for room temperature superconductors. The glasses Al—Si conductors had only weak superconductive properties at the temperature ˜10 K and were unstable under switching.

The current state of the art for the creation of the HTSC are type II Superconductors which have the composition of TlCa₄Ba₃Cu₆O₇. These superconductors can have the a Superconductive Temperature (Tₛ) of 162 K (−111° C.) (G. Bednortz, A. Muller. Discovery of High Temperature Superconductivity. Znanie, M. 1/1989). Type I Superconductors, which are limited to elemental conductors such as Zinc or Mercury, have a Tₛ in the range of 0.01-6.1 K. The leap from superconductors at the temperature of liquid helium to temperatures of liquid nitrogen superconductors have applications in a wide array of fields. They are used in transportation to propel Magnetic Trains, in medicine within devices such as Magnetic Resonance Imaging machines and utilities to minimize power fluctuations in transmission lines; however, current technology for HTSC still requires high levels of cooling and makes these applications costly. It would be useful to have a superconductor, which operates at room temperature. Once this superconductor is found, it would be further useful to have a process to synthesize it.

The synthesis of certain superconductors has been met with limited success. Some superconductors have remained undeveloped due to the complexity in actual growth of the crystal structure of the superconductor. The products of most synthetic reactions are unstable under switching and they transform to multiphase states without superconducting properties (i.e. no Meissner's effects or increased conductive ability). Meissner's effect is the expulsion of magnetic flux that occurs when a material is cooled below its superconducting transition. It is considered proof of superconductivity. The synthesis of a superconductor is more complex than finding the correct mixture of elements to form a new compound. The form and structure of the superconductor are vital whether or not it displays superconductive properties. To obtain the correct structure, very specific protocols must be developed and followed. In U.S. Pat. No. 6,034,036, synthesis of a superconductor required a specific temperature for the synthesis to occur as well as an extended cooling process combined with an oxygen stream. U.S. Pat. No. 5,665,682 demonstrates a method for creating a superconductor which requires methods for disrupting magnetic flux during the synthetic process. Each characteristic of the superconductor requires special consideration in the processing.

U.S. Pat. No. 5,439,876 describes a more complex method of creating a superconductor involving attention to crystal structure. This patent describes a method for the creation of “thin film” superconductors. Epitaxial growth of crystalline structures allows superconducting circuits to be created. This patent, however, does not reveal how to create the superconductor conductive material. The thin films generated are simply films of known superconductors. This patent does not demonstrate the creation of a new superconductor or the required structure needed for a superconductor. Particularly, one capable of high temperature superconduction above 225 K.

U.S. Pat. No. 4,999,338 demonstrates a method for making a superconducting ceramic-metal composite. This patent also uses known superconducting compounds such as YBa₂Cu₃O₇ or Bi_{1.6}Pb_{0.4}Ca₂Sr_{1.5}Cu₃O₁₀. This patent defines temperature and pressure ranges for the synthesis of these compounds, but it does not create a new superconductor.

It would be useful to have a superconductor, which operates at room temperature or at least significantly higher than liquid nitrogen. It would be useful for this superconductor to be stable under switching conditions. It would be further useful to have a method for synthesizing the superconductor. The present invention addresses these issues.

### BRIEF SUMMARY OF THE INVENTION

It is an object of the present invention to provide a method for synthesizing a High Temperature Super Conductor, whose superconducting transition lies above 225 K.

It is a further object of this invention to provide a method for forming Li₃P in a cubic phase under high pressure, which phase remains stable at STP conditions.

It is another object of this invention to provide new superconductors comprising Li₃P and Li₃P—Li₃N.

Briefly stated, the present invention provides a new type of high temperature superconductor based on cubic phase Li₃P formed at high pressures. It also provides a method for creating Li₃P in a cubic phase either by itself or with up to 10% of Li₃N by molecular proportions. The synthesis of these superconductive compounds is described. Generally, a mixture of low pressure synthesized Li₃N and Li₃P is subjected to a combination of high pressure and high heat for a certain duration. The phases are monitored during synthesis with x-ray diffraction and mass-spectrometry. The resultant materials display superconducting transitions, T_{S}, above 225 K and approaching room temperature.

The above, and other objects, features and advantages of the present invention will become apparent from the following description read in conjunction with the accompanying drawings, (in which like reference numbers in different drawings designate the same elements.)

### BRIEF DESCRIPTION OF FIGURES

FIG. 1—High Pressure Chamber, cross sectional view

### DESCRIPTION OF PREFERRED EMBODIMENTS

In the present invention, consideration was given to the long-range distance part of the interaction arising from the exchange of virtual phonons taking into account the correlation effects in an electronic fluid. To describe the electron phonon interaction an model similar to the “jelle” model was used. It is shown that, in contrast to the Coulomb interaction, the interelectronic one through the exchange of virtual phonons is not actually screened. This leads to instability relative to the formation of pairs near the Fermi surface.

A novel approach was developed to the synthesis of high temperature superconductors using High Pressure (HP) and simple compositions. Li₃P under some conditions is an unstable dielectric and thus a possible material for HP synthetic reactions. Li₃P has an energetically stable configuration in the outer p-shell, which under HP can have the form of 3s¹p6+e. This transition is similar to the structures found in the ceramic superconductors, which are doped with Copper. (e.g. La₍₂₋ₓ₎SrₓCuO₄ under La→Sr substitution an electron is selected from Cu-layers.). The near crystalline structure of Li₃P at the molecular level, and the high metal concentration suggested that under HP Li₃P would transform to a metallic superconducting form. Based on this hypothetical crystalline structure, we had predicted that the hexagonal phase of Li₃P would transform to a cubic phase under HP. This was tested and found correct. In the cubic phase, the Li₃P was found to have a superconducting transition temperature well above 225 K. Samples prepared with up to about 10% by formula weight of Li₃N were also found to form cubic phases and to have high superconducting transition temperatures approaching room temperature.

The new way of manufacturing “room temperature” HTSC is based on Li-pnictids (Li₃P, Li₃N) which produce samples with a superconducting transition temperature, Tₛ, near room temperature and which are stable under magnetic and electric switching. The first stage of synthesis of the phases is to obtain low pressure Li₃P. The mixture is then exposed to high pressure in a toroidal high pressure chamber at 50-180 kbar and temperature range between, 700-1350° C.

Partly amorphous hexagonal Li₃P has been synthesized by heating a mixture of Li-metal and red Phosphorus in Fe-Crucible. The hexagonal phase is placed in a toroidal high pressure chamber and heated under 50-180 kbar, T=700-1350° C. for one hour. The synthesis of the cubic phase Li₃P, confirmed predictions of the new phase. The formed samples of new cubic phase were small brown cylinders (approximately 3 mm in diameter and 2 mm in height) or drop shaped particles with dark brown color (approximately 3-5 mm in size). Meissner's effect was observed at near room temperature for the samples. HP solid solutions on the basis of the pnictide system Li₃P—Li₃N have been produced.

The method of production of high temperature superconductors on the base of Li-pnictides is distinguished by the initial mixture of phases low pressure (preliminary synthesized) are subjected to the influences of high pressure (50-180 Kbar) in toroidal chambers and heating.

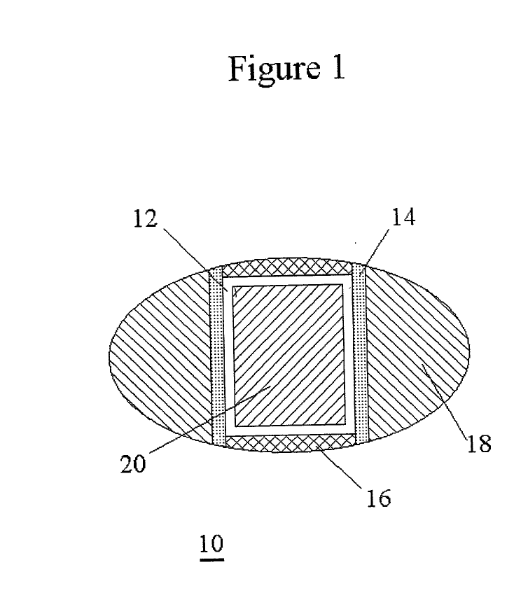

The high pressure chamber within which the synthetic reactions takes placed is described in FIG. 1. Li₃P 20 is placed in the center of chamber 10 lined with Tantalum 12. Outside of Tantalum lining 12 there is a layer of graphite 14, pirofilite 16 and lithographic stone 18.

The present invention is further illustrated by the following examples, but is not limited thereby. Where present in the initial materials, the Li₃N low pressure material was commercially available product, in contrast to the Li₃P which was synthesized as described above.

### EXAMPLE 1

Type of synthesis: High Pressure Chamber (FIG. 1)

Materials: pirofilite, graphite lithographic stone, Li₃P, Ta, Mo

Temperature—700 C.

Pressure—50 kbar,

Time of exposure—30 min.

Li₃P-transition: from hexagonal to cubic phases.

Tₛ—258 K.

### EXAMPLE 2

Type of synthesis: High Pressure Chamber (FIG. 1)

Materials: pirofilite, graphite lithographic stone, Li₃P, Ta, Mo

Temperature—1250 C.

Pressure—70 Kbar

Time of exposure—15 min.

Tₛ—262 K

### EXAMPLE 3

Type of synthesis: High Pressure Chamber (FIG. 1)

Materials: pirofilite, graphite, lithographic stone, Mo, Ta, Li₃P.

Temperature—1100 C.

Pressure—80 Kbar

Time of exposure 10 min.

Tₛ—250 K.

### EXAMPLE 4

Type of synthesis: High Pressure Chamber (FIG. 1)

Materials: pirofilite, graphite, lithographic stone, Mo, Ta, (Li₃P)x(Li₃N)₍₁₋ₓ₎, where

x=0.95.

Temperature. 1300 C.

Pressure—140 Kbar

Time of exposure—10 min.

Tₛ—275 K.

### EXAMPLE 5

Type of synthesis: High Pressure Chamber (FIG. 1)

Materials: pirofilite, graphite, lithographic stone, Mo, Ta, (Li₃P)x(Li₃N)₍₁₋ₓ₎,

where x=0.92.

Temperature. 1300 C.

Pressure—170 Kbar.

Time of exposure—10 min.

Tₛ—282 K.

### EXAMPLE 6

Type of synthesis: High Pressure Chamber (FIG. 1)

Materials: pirofilite, graphite, lithographic stone, Mo, Ta, (Li₃P)x(Li₃N)₍₁₋ₓ₎, where

x=0.91.

Temperature—1350 C.

Pressure—180 Kbar

Time of exposure—150 min

Tₛ—285 K

In all these examples the HP cubic phases were synthesized for Li₃P—Li₃N. The formed samples are generally small cylinders of brown color d=3 mm, h=2 mm or drop like weakly hygroscopic particles. Meissner's effect were observed at the temperature near room temperature by means of Co—Sm magnet.

Having described preferred embodiments of the invention with reference to the accompanying drawings, it is to be understood that the invention is not limited to the precise embodiments, and that various changes and modifications may be effected therein by skilled in the art without departing from the scope or spirit of the invention as defined in the appended claims.

What is claimed is:

1. A high temperature superconductor (HTSC) with a superconducting transition temperature, T_{S}, above 225 K and which is based on high pressure pnictides-like phase of Li₃P—Li₃N.

2. A superconductor according to claim 1, wherein said pnictides-like phase is a cubic phase of solid (Li₃P)ₓ—(Li₃N)_{(1.00-x)}, formed under high pressure; and
wherein x varies from 0.90 and 1.00.

3. A superconductor according to claim 1, wherein said superconducting transition temperature is above 250 K.

4. A method for fabricating HTSC comprising the steps of:
synthesizing a low pressure hexagonal phase of Li₃P;
mixing said low pressure phase Li₃P with low pressure prepared Li₃N in a molar ratio of xLi₃P to (1.00−x)Li₃N, wherein x varies from 0.90 to 1.00;
placing said resulting mixture in a chamber; and
heating under a pressure of 50-180 kBar, at a temperature of T=700-1350 C. for a period of 10 to 30 min.

5. A method according to claim 4 wherein said chamber preferably has a toroidal shape.

6. A method according to claim 4, wherein said low pressure synthesis of said Li₃P is performed in a Fe-crucible at 600-700 C. over 20-25 h from Li and red P.

7. A method according to claim 4 wherein all phases are monitored by means of x-ray diffraction and mass-spectrometry.
